(19) United States
(12) Patent Application Publication
(10) Pub. No.: US 2007/0280647 A1
(43) Pub. Date: Dec. 6, 2007

(54) Moving Image Processing Device, Moving Image Processing Method And Program

(76) Inventor: Toru Morita, Tokyo (JP)

Correspondence Address: KATTEN MUCHIN ROSENMAN LLP, 575 MADISON AVENUE, NEW YORK, NY, 10022-2585, US

(21) Appl. No.: 11/630,422

(22) PCT Filed: Jun. 7, 2005
(86) PCT No.: PCT/JP05/10434

§ 371 Date: Apr. 9, 2007

(30) Foreign Application Priority Data
Jun. 25, 2004 (JP) 2004-188717

(51) Int. Cl. H04N 5/00

(52) U.S. Cl. 386/121; 386/E05.003

(57) ABSTRACT

A moving image processing apparatus for generating a representative static image from movie data recorded on a recording medium is provided: in which image acquisition position information that identifies an image acquisition position in the movie data is acquired; a reproduction image at an image acquisition position identified by the acquired image acquisition position information from the movie data is acquired as a representative static image; and the acquired image acquisition position information is recorded on the recording medium in association with information that identifies the movie data.

### TECHNICAL FIELD

The present invention relates to a moving image processing apparatus, a moving image processing method, and a program for such as authoring a DVD.

### BACKGROUND ART

Apparatuses (such as DVD recorders) for recording moving images such as TV programs using a DVD (Digital Versatile Disk) are becoming widespread. Generally in a DVD, when a plurality of moving images are recorded, a so-called menu screen that presents a list of the recorded moving images is also recorded with the moving images to facilitate the selection and playback of each of the moving images. The menu screen usually includes thumbnail images of each of the moving images. Now, a method for generating menu screens in a conventional DVD recorder will be explained below.

In conventional DVD recorders, the playback image specified by the user is retrieved from each of the moving images recorded in a DVD as a representative static image for each moving image. The retrieved representative static images are compressed to generate thumbnail images. Then, the generated thumbnail images are arranged at predetermined positions to generate image data that is used as a menu screen. The image data is recorded as a menu screen in the processed DVD. An example of a screen of a product in which the background of the menu screen is selectable is disclosed in the section for explaining functions of “title menu”, Pioneer Corp. Ltd., DVD Recorder brochure, March 2004, p. 18.

However, the above processing in conventional DVD recorders has the following problems. That is, because an individual thumbnail image that is generated from each moving image is not recorded when the menu screen needs to be updated due to a new recording of a moving image or the like, the generation of thumbnail images has to be repeated from the beginning. In addition, in the generation of a menu screens, if a user specifies a scene among others to be used as a thumbnail image, the user has to specify the scene again, which lowers convenience.

The present invention was made in view of the above situations, and one object of the present invention is to provide a moving image processing apparatus that facilitates the regeneration of thumbnail images as an update of the menu screen and the like to enhance convenience.

### DISCLOSURE OF THE INVENTION

In order to solve the problems in the above conventional example, the present invention provides a moving image processing apparatus for generating a representative static image from the movie data recorded on a recording medium, comprising: devices for acquiring image acquisition position information that identifies the image acquisition position in the movie data from a user; devices for acquiring a playback image at an image acquisition position identified by the acquired image acquisition position information from the movie data as a representative static image; and devices for recording the acquired image acquisition position information in the recording medium in association with information that identifies the movie data, and the acquired representative static image is provided to a predetermined processing function.

### BRIEF DESCRIPTION OF THE DRAWINGS

FIG. 1 is a structural block diagram showing an embodiment of a moving image processing apparatus according to the present invention;

FIG. 2 is a function block diagram showing an example of a program that is executed by an embodiment of a moving image processing apparatus according to the present invention;

FIG. 3 is a diagram illustrating an example of stored image acquisition position information; and

FIG. 4 is a flowchart showing an example of processing by an embodiment of a moving image processing apparatus according to the present invention.

### BEST MODE FOR CARRYING OUT THE INVENTION

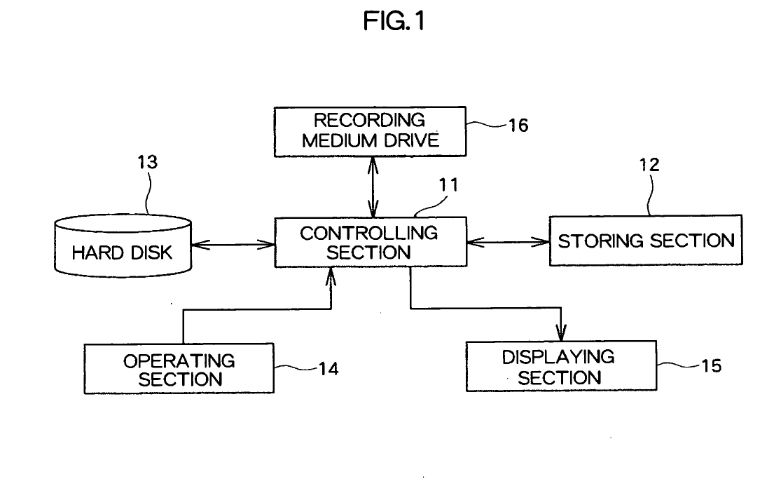

Now, an embodiment of the present invention will be explained below with reference to the accompanying drawings. An embodiment of a moving image processing apparatus according to the present invention is configured to include, as shown in FIG. 1, a controlling section 11, a storing section 12, a hard disk 13, an operating section 14, a displaying section 15, and a recording medium drive 16.

The controlling section 11 is achieved using an MPU (Micro Processing Unit), for example. The controlling section 11 is operated by a program stored in the storing section 12, and executes processing for generating a representative static image using movie data recorded on a recording medium (e.g., a DVD) that is set in the recording medium drive 16. Using the representative static image, the controlling section 11 executes processing for generating a thumbnail image or image data that will constitute a menu screen. Each processing will be specifically explained below in detail. Hereinafter, any writable recording medium associated with DVD technology, such as DVD-RW or DVD+RW, will be referred as to a “DVD”.

The storing section 12 is configured with a memory device, such as RAM (Random Access Memory). The storing section 12 stores a program to be executed by the controlling section 11 therein. The storing section 12 also operates as work memory for temporarily holding the various data that is generated in processing by the controlling section 11. The hard disk 13 is a recording medium for storing and holding movie data and the like.

The operating section 14 includes a keyboard, a mouse, a game controller, buttons and the like, and receives instructions given by a user, and outputs the given instruction to the controlling section 11. The displaying section 15 is configured with a display controller and the like, and outputs a picture signal based on the image data to an exterior display, TV or the like in response to the instructions from the controlling section 11. The displaying section 15 may include a luminous element such as an LED therein, and causes the luminous element to be turned on/off based on the signal that is input from each section including the controlling section 11 and the hard disk 13.

The recording medium drive 16 receives a recording medium such as a CD-R, a DVD, or a Blu-ray Disc™ therein for writing information in the recording medium in response to instructions input from the controlling section 11 or reading out information from the recording medium to output the information to the controlling section 11. Hereinafter, any medium that is set in the recording medium drive 16 will be referred to as a “recording medium”.

Now, an exemplary program that is executed by the controlling section 11 will be explained. In a moving image processing apparatus of this embodiment, the image to be played back, which is specified by the user for each moving image at the image acquisition position is used as the thumbnail image. That is, upon receipt of an operation that instructs the recording of the specification of a position in movie data, the controlling section 11 stores the image acquisition position information that presents the specified image acquisition position and information that identifies the movie data of interest on the hard disk 13 in association with each other. The position in the movie data can be specified by, for example, the elapsed time from the start of the moving image (e.g., by units of hours, minutes, seconds or the number of images), i.e., a time code. Alternatively, the position can be specified by information that presents the record position in a recording medium.

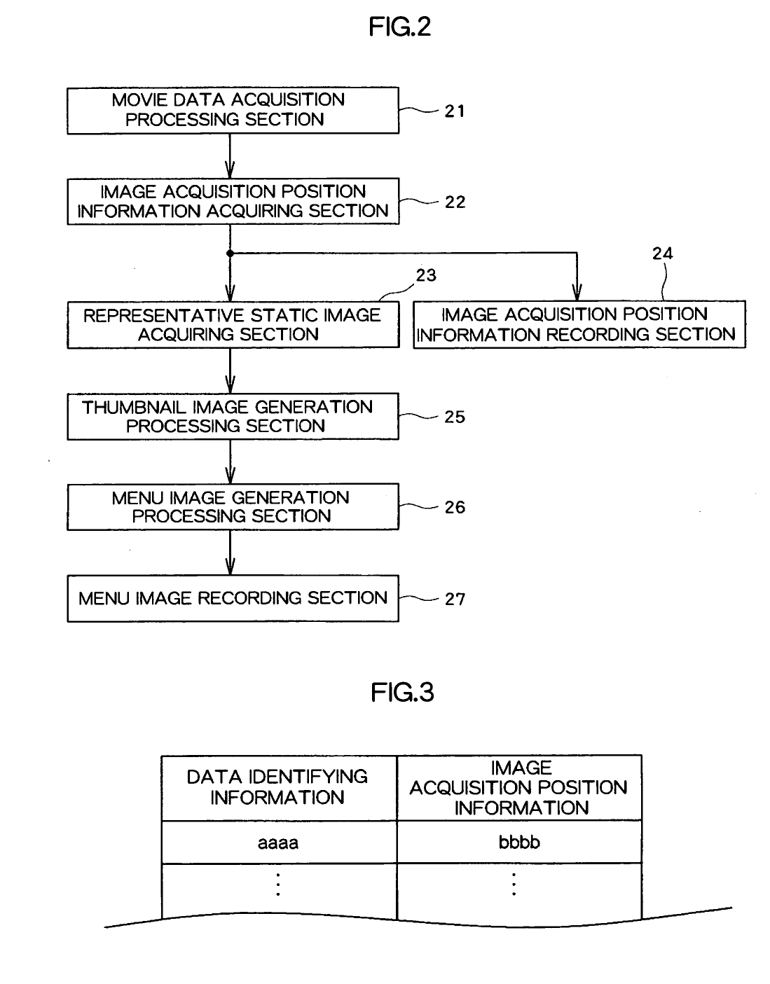

The controlling section 11 also performs processing for generating a menu image when movie data is recorded on a recording medium for example. In this processing for generating a menu image, the controlling section 11 is functionally configured, as shown in FIG. 2, with a movie data acquisition processing section 21, an image acquisition position information acquiring section 22, a representative static image acquiring section 23, an image acquisition position information recording section 24, a thumbnail image generation processing section 25, a menu image generation processing section 26 and a menu image recording section 27.

The movie data acquisition processing section 21 gives an instruction to the recording medium drive 16 to acquire a list of movie data recorded on the recording medium. With this processing, a list that shows movie data files (for example) can be acquired. Upon the acquisition of the list of movie data from the recording medium drive 16, the movie data acquisition processing section 21 sequentially outputs information that identifies movie data in the list (data identifying information) to the image acquisition position information acquiring section 22.

The image acquisition position information acquiring section 22 acquires image acquisition position information that presents the image acquisition position of the movie data that is identified by the data identifying information input by the movie data acquisition processing section 21. Specifically, the image acquisition position information acquiring section 22 checks whether the image acquisition position information of the identified movie data is recorded on the recording medium or not, and if recorded, reads out the image acquisition position information from the recording medium to output the information with the data identifying information to the representative static image acquiring section 23 and the image acquisition position information recording section 24.

Also, if the image acquisition position information of the identified movie data is not recorded in the recording medium, the image acquisition position information acquiring section 22 checks whether or not the image acquisition position information of the identified movie data is recorded on the hard disk 13. If the image acquisition position information of the identified movie data is recorded on the hard disk 13, the image acquisition position information acquiring section 22 reads out the image acquisition position information from the hard disk 13 to output the information with the data identifying information to the representative static image acquiring section 23 and the image acquisition position information recording section 24.

Moreover, if the image acquisition position information of the identified movie data is recorded on neither the recording medium nor on the hard disk 13, the image acquisition position information acquiring section 22 outputs information that presents the head position of the movie data to be played back for the image acquisition position information, with the data identifying information, to the representative static image acquiring section 23 and the image acquisition position information recording section 24. In this embodiment, the head position of the movie data to be played back is output, but alternatively, a prepared default image, for example, may be output to the thumbnail image generation processing section 25 as a representative static image.

The representative static image acquiring section 23 receives input of the data identifying information and the image acquisition position information. Then, the representative static image acquiring section 23 acquires the image to be played back (reproduction image) at the image acquisition position that is identified by the received image acquisition position information, from the movie data identified by the data identifying information, as a representative static image. For example, the representative static image acquiring section 23 plays back the image at the image acquisition position that is identified by the image acquisition position information based on the movie data, and captures the data of the played image into the storing section 12 as a static image, thereby acquiring a representative static image. The term “image acquisition position” as used herein specifically means the position to be played back that is presented by a time stamp. The representative static image acquiring section 23 outputs the acquired representative static image and the data identifying information for identifying the movie data from which the representative static image is retrieved to the thumbnail image generation processing section 25.

The image acquisition position information recording section 24 gives an instruction to the recording medium drive 16 to write the data identifying information, and the image acquisition position information that presents the position in the movie data identified by the data identifying information from which a representative static image is retrieved, into the recording medium. Since the image acquisition position information in the movie data stored on the recording medium is input sequentially, the image acquisition position information recording section 24, as shown in FIG. 3, may store data identifying information for identifying movie data, and image acquisition position information for presenting an image acquisition position in the movie data that associates them with a specific file name.

The thumbnail image generation processing section 25 receives input of the representative static image. Then, the thumbnail image generation processing section 25 compresses the representative static images into a predetermined size to generate thumbnail images. For example, when a user selects the background of a menu image, thumbnail images may be compressed into a predetermined size depending on the type of the background. The menu image generation processing section 26 arranges and synthesizes the thumbnail images generated by the thumbnail image generation processing section 25 on the background of the given menu image, thereby generating menu image data.

The menu image recording section 27 gives an instruction to the recording medium drive 16 to record the menu image data generated at the menu image generation processing section 26 onto the recording medium. In this way, in this embodiment, representative static images obtained from movie data are provided to the processing section for generating thumbnail images and generating menu images.

Next, the operation of a moving image processing apparatus of this embodiment will be described below. In the following, an operation will be explained in which two movie data A and B stored on a hard disk are regenerated onto a recording medium (which is a DVD-RW in this embodiment) for recording, and movie data P is recorded on the DVD-RW in advance. In addition to the movie data P, a menu screen that includes a thumbnail image of the movie data P, and image acquisition position information on the movie data P are also recorded on the DVD-RW in advance.

The moving image processing apparatus acquires image acquisition position information on each movie data by receiving an operation by a user. Specifically, when a scene that a user wants to use as a thumbnail is displayed during playback of the movie data A by the moving image processing apparatus, the user gives an instruction to record a specification of the position of the scene. Then, the moving image processing apparatus records data identifying information for identifying the movie data A and a time code corresponding to the scene that was displayed at the time of the operation to give the instruction, in association with each other, onto the hard disk 13.

Similarly for the movie data B, the user gives an instruction to record a specification of the position of the scene that the user wants to use as a thumbnail. In this way, information that identifies the time point when a screen for generating the thumbnail is presented (image acquisition position information) is recorded onto the hard disk 13.

Next, when the user inserts a DVD-RW in the recording medium drive 16, and operates it to cause the movie data A and B to be regenerated onto the DVD-RW, the moving image processing apparatus copies the movie data A and B from the hard disk 13 onto the DVD-RW to cause the movie data A and B to be recorded thereon. This results in the three movie data P, A, and B recorded in the DVD-RW.

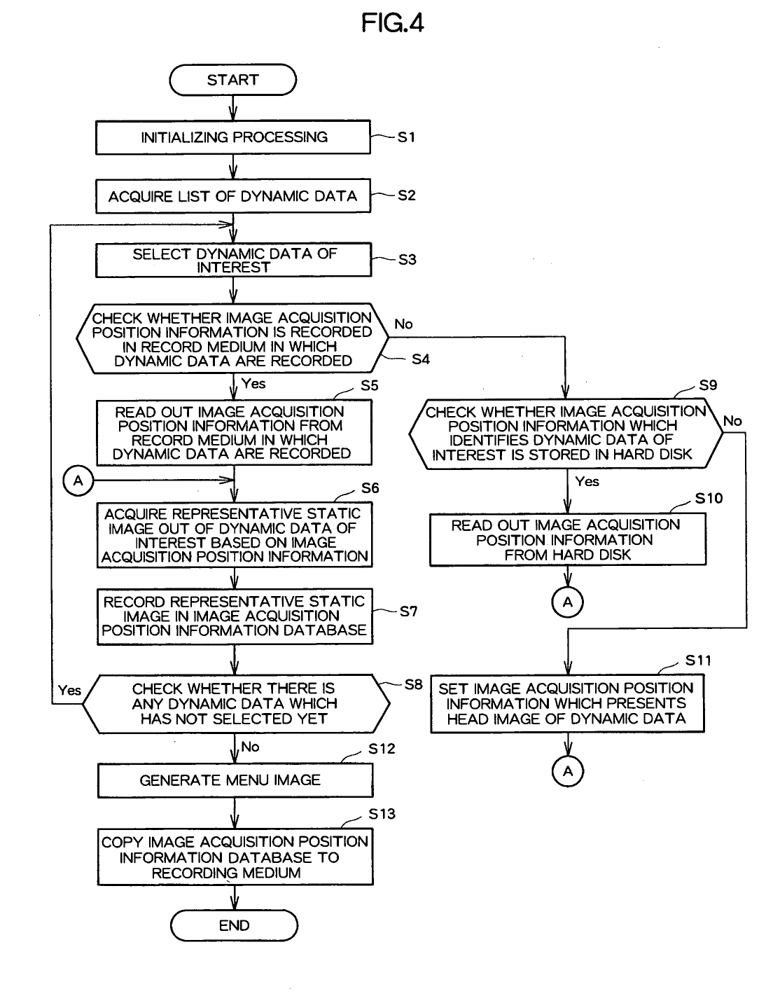

When the copy is completed, the moving image processing apparatus starts processing for generating a menu image. That is, the controlling section 11 of the moving image processing apparatus, as shown in FIG. 4, initializes and generates a file that is the source of the image acquisition position information database (i.e., generates an empty file), and stores it in the storing section 12 (S1: initializing processing). Then, the controlling section 11 acquires a list of movie data recorded on the DVD-RW (S2). Since the movie data P, A, and B are recorded in this embodiment, data identifying information that identifies this movie data is acquired. The data identifying information may be the file names of each movie data, for example. Next, the controlling section 11 selects one of the movie data that has not been selected before from the movie data list as movie data of interest (S3) and checks whether or not the image acquisition position information regarding the movie data of interest is recorded on the DVD-RW (the recording medium in which the movie data is recorded) (S4). If the image acquisition position information is recorded (if Yes), the image acquisition position information is read out from the recording medium (S5).

In the case of this example, the image acquisition position information regarding the movie data P is recorded in advance. Thus, if the movie data of interest is the movie data P, the image acquisition position information is read out from the DVD-RW.

The controlling section 11 plays back an image at an image acquisition position that is identified by the image acquisition position information out of the movie data of interest, and captures the data of the played image into the storing section 12 as a static image for a representative static image (S6). The representative static image is stored in association with the data identifying information regarding the movie data of interest, in the storing section 12.

Moreover, the controlling section 11, as shown in FIG. 3, records the data identifying information of the movie data of interest and the image acquisition position information in association with each other into an image acquisition position information database of the storing section 12 (S7). The controlling section 11 checks whether or not there is any movie data that has not been selected as movie data of interest (S8), and if there is any movie data that has not been selected (if YES), it goes back to processing S3 to select one of the movie data that has not selected, and so on.

Meanwhile, at processing S4, if no image acquisition position information on the movie data of interest is recorded in the DVD-RW (if NO), the controlling section 11 checks whether or not image acquisition position information that identifies the movie data of interest is stored on the hard disk 13 (S9). If the image acquisition position information is stored on the hard disk 13 (if YES), the image acquisition position information is read out from the hard disk 13 (S10), and processing advances to processing S6.

In this example, for each of the movie data A and B, information on the position to be played back to acquire each representative static image (image acquisition position) is stored on the hard disk 13. Thus, the representative static images for each movie data A and B are acquired using the image acquisition positions identified by the information stored on the hard disk 13 in relation to each movie data A and B.

Furthermore, if no image acquisition position information on the movie data of interest is stored on the hard disk 13 (if NO), the controlling section 11, at processing S9, acquires information that presents a head image of the movie data of interest (the first image of the movie data of interest at 0 seconds by the time code) for the image acquisition position information (S11), and processing advances to processing S6.

Also, at processing S8, when there is not any movie data left that has not yet been selected, that is, when processing for all movie data is completed, the controlling section 11 generates a menu image using each representative static image stored in the storing section 12 (S12). The controlling section 11 further copies the image acquisition position information database stored on the hard disk 13 to the DVD-RW to make the database recorded thereon (S13), and ends processing. At processing S12, each representative static image data may be compressed to generate thumbnail images, which are arranged and synthesized on a background of the menu image, resulting in the generation of a menu image.

The controlling section 11 gives an instruction to the recording medium drive 16 to record the generated menu image data on the DVD-RW. This allows the menu image to be updated.

As described above, according to this embodiment, for the movie data P that has been recorded on the DVD-RW in advance, the image that is the same as the thumbnail image used in the menu screen before the update is regenerated as a thumbnail image for the menu screen after such update. This regeneration eliminates any operations such as the acquisition of a new thumbnail image, which enhances convenience.

In updating the menu screen of the DVD-RW later, since information on positions to acquire the images that are the source of the thumbnail images for each movie data P, A, and B is recorded on the DVD-RW, the thumbnail images can be regenerated using the information.

In the above explanation, in the case where a user specifies the image acquisition position in movie data, the moving image is played back so that, during playback, the user gives an instruction to record a position of the moving image, but the following may be admitted. That is, the controlling section 11 extracts at least one screen that satisfies a predetermined image condition out of screens on which the movie data is being played back and presents a list of the extracted screens on the displaying section 15. Then, the user selects an image acquisition position of a representative static image out of the screen list presented by the displaying section 15.

The predetermined image condition includes, for example, those in which a region having a color corresponding to flesh color occupies 50% or more of a screen. Under this condition, for example in movie data obtained by recording a TV picture, when the face of a cast member appears on a TV screen resulting a flesh color region occupying 50% or more of the screen, a static image at the scene is presented as a candidate for a representative static image.

In order to perform the above processing, a played back image of the movie data is periodically retrieved, for example every 10 seconds, to compute the percentage flesh color occupying the played back image. This computation may be performed for example by comparing a pixel value of a pixel with a range of a predetermined flesh color value on a pixel basis, counting the number of pixels within the range of the flesh color value, and dividing the counted number by the total number of pixels on the entire screen. Then, the percentage is checked to see if it is above a predetermined percentage threshold or not, and if it is above the threshold, the played back image is copied to the storing section 12 as a candidate for presentation. In presentation, each played back image stored in the storing section 12 as a candidate for presentation may be compressed to be displayed as a list on the screen.

If the number of candidates for presentation exceeds a predetermined limit, the percentage threshold may be updated to a higher value to reselect candidates for presentation.

Alternatively, when categories for programs can be obtained from program information, the percentage threshold may be changed depending on the category information. For example, in a category such as new programs in which the face of a person often appears on a TV screen, the percentage threshold can be set to be higher.

Also in the above explanation, a file name is used as information for identifying movie data, but instead of this, information on the recorded position on the recording medium (such as address information based on the head position of the entire recorded image data, when the image data is sequentially recorded on the recording medium) may be used as information for identifying movie data.

1. A moving image processing apparatus for generating a representative static image from movie data recorded on a recording medium, comprising:
devices for acquiring image acquisition position information that identifies an image acquisition position in the movie data from a user;
devices for acquiring a reproduction image at an image acquisition position identified by the acquired image acquisition position information from the movie data as a representative static image; and
devices for recording the acquired image acquisition position information on the recording medium in association with information that identifies the movie data, and
the acquired representative static image is provided to a predetermined processing function.

2. A moving image processing apparatus for generating a representative static image from movie data recorded on a recording medium, comprising:
devices for acquiring image acquisition position information that identifies an image acquisition position in the movie data by reading out the image acquisition position information from the recording medium; and
representative static image acquiring means for acquiring a reproduction image at an image acquisition position identified by the acquired image acquisition position information from the movie data as a representative static image, and
the acquired representative static image is provided to a predetermined processing function.

3. The moving image processing apparatus according to claim 2, wherein, when no image acquisition position information on movie data is recorded on the recording medium,
the representative static image acquiring devices acquires a reproduction image at a predetermined image acquisition position in the movie data as a representative static image.

4. A moving image processing method for generating a representative static image from movie data recorded on a recording medium, that causes a computer to execute:
a step for acquiring image acquisition position information that identifies an image acquisition position in the movie data from a user;
a step for acquiring a reproduction image at an image acquisition position identified by the acquired image acquisition position information from the movie data as a representative static image; and
a step for recording the acquired image acquisition position information on the recording medium in association with information that identifies the movie data, and wherein
the acquired representative static image is provided to a predetermined processing function.

5. A moving image processing method for generating a representative static image from movie data recorded on a recording medium, causing a computer to execute:
a step for acquiring image acquisition position information that identifies an image acquisition position in the movie data by reading out the image acquisition position information from the recording medium; and
a step for acquiring a reproduction image at an image acquisition position identified by the acquired image acquisition position information from the movie data as a representative static image, and wherein
the acquired representative static image is provided to a predetermined processing function.

6. A computer readable recording medium that stores a program for generating a representative static image from movie data recorded on a recording medium, the program enabling a computer to execute:
a procedure for acquiring image acquisition position information that identifies an image acquisition position in the movie data from a user;
a procedure for acquiring a reproduction image at an image acquisition position identified by the acquired image acquisition position information from the movie data as a representative static image; and
a procedure for recording the acquired image acquisition position information on the recording medium in association with information that identifies the movie data, and wherein
the acquired representative static image is provided to a predetermined processing function.

7. A computer readable recording medium that stores a program for generating a representative static image from movie data recorded on a recording medium, enabling a computer to execute:
a procedure for acquiring image acquisition position information that identifies an image acquisition position in the movie data by reading out the image acquisition position information from the recording medium; and
a procedure for acquiring a reproduction image at an image acquisition position identified by the acquired image acquisition position information from the movie data as a representative static image, and wherein
the acquired representative static image is provided to a predetermined processing function.
